(19) United States
(12) Patent Application Publication
(10) Pub. No.: US 2008/0105992 A1
(43) Pub. Date: May 8, 2008

(54) MIXED MASSES SEALANT

(75) Inventors: Jason Walker, Lenox, MI (US); Matthew Harthcock, Oakland Twp., MI (US); Kevin Hicks, Harrison Twp., MI (US)

Correspondence Address: DOBRUSIN & THENNISCH PC, 29 W LAWRENCE ST, SUITE 210, PONTIAC, MI, 48342, US

(73) Assignee: Zephyros, Romeo, MI (US)

(21) Appl. No.: 11/934,942

(22) Filed: Nov. 5, 2007

Related U.S. Application Data
(60) Provisional application No. 60/864,900, filed on Nov. 8, 2006.

(51) Int. Cl. B29C 44/06; C08L 63/00

(52) U.S. Cl. 264/45.4; 523/400

(57) ABSTRACT

The present invention relates to a sealer having a plurality of first masses and a plurality of second masses with the first masses having a different characteristic (i.e., different expandability) than the second masses. The sealer is particularly effective as baffle for structures of automotive vehicles.

### CLAIM OF PRIORITY

This application claims the benefit of the filing date of U.S. Provisional Ser. No. 60/864,900 filed Nov. 8, 2006.

### FIELD OF THE INVENTION

The present invention relates to a sealer having a plurality of first masses and a plurality of second masses with the first masses having a different characteristic than the second masses. More particularly, the invention relates to a sealer having first masses of activatable material and second masses of activatable material wherein the second masses exhibit relatively high expansion compared to the first masses.

### BACKGROUND OF THE INVENTION

Industry, particularly the automotive industry, has been seeking to form improved sealants, particularly baffles for automotive vehicles and other articles of manufacture. Traditionally, automotive baffles have been formed of a carrier that is designed to span a cavity of a structure of an automotive vehicle wherein that carrier would include expandable, (e.g., foamable) material about its periphery. When placed in the cavity, the expandable material could be expanded to seal between the periphery of the carrier and the walls of the structure. Formation of such baffles can be expensive since it often requires the formation of a relatively complex shaped carrier using relatively expensive equipment. Moreover, formation of such baffles can require expensive processing machinery to form and locate the expandable material as desired. As such, it would be desirable to form a seal, particularly a baffle, that is relatively easy to manufacture and is relatively low cost.

### SUMMARY OF THE INVENTION

Accordingly, the present invention discloses a sealer, a method of forming the sealer and/or a method of baffling or sealing a structure with the sealer. For the sealer, there is provided a plurality of first masses of activatable material and a plurality of second masses of activatable material. The activatable material of the first masses is either a relatively low expanding material or non-expanding material. The plurality of first masses typically includes as least five masses. In a preferred embodiment, the activatable material of the first masses can include at least about 10% by weight epoxy resin. Moreover, the activatable material of the first masses typically expands to a volume that is at least 140% but less than 500% relative to its original volume before expansion. The activatable material of the second masses is a relatively high expanding material as compared to the activatable material of the first masses. The plurality of first masses also typically includes as least five masses. In a preferred embodiment, the activatable material of the second masses includes an acrylate, an acetate or both. Moreover, the activatable material of the second masses typically expands to a volume that is at least 700% relative to its original volume before expansion. The plurality of first masses are agglomerated with the plurality of second masses for forming a sealer. The sealer can be located within a cavity of a structure of an automotive vehicle and the plurality of first masses, the plurality of second masses or both can be configured to expand and adhere to walls of the structure when exposed to an elevated temperature during automotive processing. Typically, the elevated temperature experienced during automotive processing is at least 150° C. The sealer can be shaped to correspond to the cavity of the structure of the automotive vehicle if desired. Moreover, if desired, the sealer, after activation, can continuously span across a cross-section of the cavity for inhibiting the passage of mass, sound or both through the cavity thereby acting as a baffle.

### BRIEF DESCRIPTION OF THE DRAWINGS

The features and inventive aspects of the present invention will become more apparent upon reading the following detailed description, claims, and drawings, of which the following is a brief description:

FIG. 1 illustrates an exemplary application of an exemplary method of forming a sealer according to an aspect of the present invention.

FIG. 2 illustrates a close-up view of an exemplary alternative sealer within the scope of the present invention.

### DETAILED DESCRIPTION OF THE INVENTION

The present invention is predicated upon the formation of an agglomeration of masses (e.g., pellets) of adhesive material for the formation of a sealant. The agglomeration of masses is typically comprised of at least one or a plurality of first relatively low expanding or non-expanding masses (e.g., structural pellets) and at least one or a plurality of second relatively high expanding masses (expanding pellets). As used herein, a plurality of masses (e.g., pellets), as referring to the first or second masses, can include at least two, but typically includes at least three, more typically at least five and even more typically at least ten masses of adhesive material Generally, it is desirable for the first masses and the second masses to be well dispersed throughout the agglomeration or sealant, although not required unless otherwise stated.

For the present invention, various amounts of materials are discussed as being in the first masses, the second masses or both. Where percentages are specified, is those percentage are weight percentages unless otherwise specified.

The material of the relatively low or non-expanding masses can be formed of a variety of ingredients. Such ingredients will typically include two or any combination of polymeric base material, blowing agent and/or accelerator, curing agent and/or accelerator, filler, reinforcement material, and additive. The polymeric base material may be a single polymeric material or multiple different polymeric materials. Suitable polymers for the polymeric base material can be, without limitation, elastomers, thermoplastics, thermosettables, elastomer adducts, plastics, thermoplastic elastomers, combinations thereof or the like. Typically it is preferable for the polymeric base material to include a substantial amount of an epoxy resin and/or be epoxy based, although not required unless otherwise stated. When included, the epoxy resin, which can include a combination of multiple types of epoxy resins, is typically at least about 10%, more typically at least about 20% and even more typically at least about 30% and possibly at least about 40 or 50% by weight of the activatable material of the relatively low or non-expanding masses. The low expanding or non-expanding masses, when expandable (e.g., foamable) are typically configured to expand to an expanded volume that is greater than about 101%, more typically greater than 140% and still more typically greater than 200% of the original non-expanded volume of the masses (e.g., as used herein, 200% of an original non-expanded volume of 10 cm³ is 20 cm³). The expanded volume is also typically less than about 500%, more typically less than 300% and even possibly less than 200% of the original non-expanded volume of the masses. Examples of materials suitable for the relatively low or non-expanding masses are disclosed in U.S. Pat. Nos. 7,125,461; 7,111,899; 6,921,130; and 6,846,559, al: of which are incorporated herein by reference for all purposes. Preferred materials for the first masses are sold under the tradenameL-5600, L-9003, L-9002, L-9001, which are commercially available from L&L Products, Romeo, Mich.

The material of the relatively high expanding masses can also be formed of a variety of ingredients. Such ingredients will also typically include two or any combination of polymeric base material, blowing agent and/or accelerator, curing agent and/or accelerator, filler, reinforcement material, and additive. The polymeric base material can also be a single polymeric material or multiple different polymeric material. Suitable polymers for the polymeric base material of the relatively high expanding masses can be, without limitation, elastomers, thermoplastics, thermosettables, elastomer adducts, plastics, thermoplastic elastomers, combinations thereof or the like. Typically, it is preferable for the polymeric base material to include a substantial amount of sealant polymer. As used herein, sealant polymer can include any polymer with a relatively high degree of stretchability or elasticity. For example, a cured, cross-linked or thermoset sealant polymer typically includes polymers with a higher degree of stretchability or elasticity relative to the stretchability or elasticity of a cured, cross-linked or thermoset epoxy resin when those materials are subject to the same external conditions (e.g., temperature). Examples of polymers suitable for the sealant polymer can include elastomers, acetates (e.g., EVA), acrylates (e.g., EMA), ethylene polymers (e.g., EPDM), combinations thereof or the like. When included, the sealant polymer is typically at least about 10%, more typically at least about 20% and even more typically at least about 30% and possibly at least about 40 or 50% of the material of the relatively low or non-expanding masses. The relatively high expanding (e.g., foaming) masses are typically configured to expand to an expanded volume that is greater than about 250%, more typically greater than 400% and still more typically greater than 700% and possibly greater than about 1000, 1500, 2000 or 2500% of the original non-expanded volume of the masses (e.g., as used herein, 1000% of an original non-expanded volume of 10 cm³ is 100 cm³). Examples of materials suitable for the relatively high expanding masses are disclosed in U.S. Pat. Nos. 2004/0266898; 6,926,784; 6,923,499; 6,710,115; and 6,383,610 all of which are incorporated herein by reference for all purposes. One preferred material for the relatively high expanding masses is sold under the tradename L-7220, which is commercially available from L&L Products, Romeo, Mich.

The materials of the relatively high expanding masses and the relatively low or non-expanding masses can also include one or an admixture of 2, 3, 4 or several additional or alternative polymers, which can be thermoplastics, thermosettables, elastomers, plastomers combinations thereof or the like. For example, and without limitation, polymers that might be appropriately incorporated into either of the material of the masses include halogenated polymers, polycarbonates, polyolefins (e.g., polyethylene, polypropylene), polyethylenes, phenoxy resins, polypropylenes, poly(ethylene oxides), polysiloxane, polyethers, polyphosphazines, poly(ethyleneimines), polyamides, polyketones, polyurethanes, polyesters, polyimides, polyisobutylenes, polyacrylonitriles, poly(vinyl chlorides), poly(methyl methacrylates), poly(vinyl acetates), poly(vinylidene chlorides), polytetrafluoroethylenes, polyisoprenes, polyacrylamides, silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer), EPDM and any combination or mixtures thereof. Examples of suitable elastomers include, without limitation natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like.

It is contemplated that the material of the relatively high expanding masses, the relatively low expanding masses or both may be without any curing agent, can include a single curing agent or may employ two or more curing agents. When two or more curing agents are employed, it is contemplated that the two or more agents can be from the same class or different class of curing agents and may be directed at curing same or different polymeric materials.

Amounts of curing agents and curing agent accelerators can vary widely within the materials of the masses depending upon the type of cellular structure desired, the desired amount or rate of expansion of the masses or the like. Exemplary ranges for effective amounts of the curing agents, curing agent accelerators or both together present in the material of the masses range from about 0.1% by weight to about 7% by weight.

Preferably, the curing agents assist the material of the masses in curing by crosslinking of the polymers, epoxy resins or both. It is also preferable for the curing agents to assist in thermosetting the materials. Useful classes of curing agents are materials selected from aliphatic or aromatic amines or their respective adducts, amidoamines, polyamides, cycloaliphatic amines, (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), peroxides or peroxy materials, sulfur or mixtures thereof. Particularly preferred curing agents include modified and unmodified polyamines or polyamides such as triethylenetetramine, diethylenetriamine tetraethylenepentamine, cyanoguanidine, dicyandiamides and the like. An accelerator for the curing agents (e.g., a modified or unmodified urea such as methylene diphenyl bis urea, an imidazole or a combination thereof) may also be provided for preparing the materials.

Blowing Agent

One or more blowing agents may be employed to achieve expansion (e.g., foaming) of the relatively high expanding masses, the relatively low or non-expanding masses or both. In this manner, it may be possible to lower the density of articles fabricated from the material. In addition, the material expansion can help to improve sealing capability, acoustic damping or both.

The blowing agent[s] may include one or more nitrogen containing groups such as amides, amines and the like, Examples of suitable blowing agents include azodicarbonamide, dinitrosopentamethylenetetramine, 4,4ᵢ-oxy-bis-(benzenesulphonylhydrazide), trihydrazinotriazine and N, Nᵢ-dimethyl-N,Nᵢ-dinitrosoterephthalamide.

An accelerator for the blowing agent[s] may also be provided in the materials of the masses. Various accelerators may be used to increase the rate at which the blowing agents form inert gasses. One preferred blowing agent accelerator is a metal salt, or is an oxide, e.g. a metal oxide, such as zinc oxide. Other preferred accelerators include modified and unmodified thiazoles or imidazoles.

Amounts of blowing agents and blowing agent accelerators can vary widely within the material of either of the masses depending upon the type of cellular structure desired, the desired amount of expansion of the adhesive material, the desired rate of expansion and the like. Exemplary ranges for the amounts of blowing agent and blowing agent accelerator in the adhesive material range from about 0.001% by weight to about 17% by weight and are preferably in the materials in fractions of weight percentages.

Preferably, the materials, the blowing agent or both of the present invention are thermally activated. Alternatively, other agents may be employed for realizing activation by other means, such as moisture, radiation, or otherwise.

The material of the relatively low expanding or non-expanding masses or the relatively high expanding masses may also include one or more fillers, including but not limited to particulated materials (e.g., powder), beads, microspheres, nanoparticles or the like. Preferably the filler includes a relatively low-density material that is generally non-reactive with the other components present in the material of the masses.

Examples of fillers include silica, diatomaceous earth, glass, clay, talc, pigments, colorants, glass beads or bubbles, glass, carbon ceramic fibers, antioxidants, and the like. The clays that may be used as fillers may include nanoparticles of clay and/or clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite, wollastonite or mixtures thereof. The clays may also include minor amounts of other ingredients such as carbonates, feldspars, micas and quartz. Titanium dioxide might also be employed. In one or more embodiments of the present invention, it can be desirable for as substantial portion (e.g., 40%, 70% or more) of the fillers (e.g., the mineral fillers such as wollastonite or the others) to have a relatively high aspect ratio of greater than or equal to 2 to 1, although possibly lower, more typically greater than or equal to 3 or 4 to 1, and possibly greater than or equal to 8 to 1, 12 to 1, 20 to 1 or more.

In one preferred embodiment, one or more mineral or stone type fillers such as calcium carbonate, sodium carbonate or the like may be used as fillers. In another preferred embodiment, silicate minerals such as mica may be used as fillers.

When employed, the fillers in the sealant material can range from 1% to 90% by weight of the materials of the masses. According to some embodiments, the sealant material may include from about 3% to about 30% by weight, and more preferably about 10% to about 20% by weight clays, mineral fillers or other fillers.

It is contemplated that one of the fillers or other components of the material may be thixotropic for assisting in controlling flow of the material as well as properties such as tensile, compressive or shear strength.

Other Additives

Other additives, agents or performance modifiers may also be included in the material of either type of masses as desired, including but not limited to a UV resistant agent, a flame retardant, an impact modifier, a heat stabilizer, a UV photoinitiator, a colorant, a processing aid, an anti-oxidant, a lubricant, a coagent, a reinforcement materials (e.g., chopped or continuous glass, glass fiber, ceramics and ceramic fibers, aramid fibers, aramid pulp, carbon fiber, acrylate fiber, polyamide fiber, polypropylene fibers, combinations thereof or the like). In one preferred embodiment, for example, an acrylate coagent may be employed for enhancing cure density.

It is also contemplated that masses of relatively lightweight material may be dispersed throughout the sealer. Such lightweight masses may be within the material of the first masses, the second masses or both and/or may be interstitial with the first and/or second masses. When used, several (e.g., at least 10, at least 100, at least 1000) of these lightweight masses are dispersed in the sealer. In one embodiment, these lightweight masses are formed a foamed or cellular material that is preferably a polymeric material. In such an embodiment, thermoplastic expanded (e.g., foamed) cellular masses (e.g., beads) such as styrenic or polystyrene beads may be employed. Alternatively or additionally, fiber filled masses (e.g., beads), with may also be polymeric can be used.

The formation and shaping of the agglomeration and/or sealant is described later herein, however, once formed, the agglomeration can be formed or shaped as a sealant of sealer that can be applied to a variety of articles of manufacture such as buildings, furniture, vehicles (e.g., automotive or aerospace vehicles) or the like. In or for such articles, the sealer can be used to seal gaps, holes or other openings. The sealer has been found particularly useful as a baffle for automotive vehicle.

As an example, the sealer can be inserted within a cavity of a structure of an article of manufacture such as a pillar, frame member, body member or the like of an automotive vehicle. The sealer, upon activation of the masses adheres itself to walls of the structure defining the cavity by virtue of expansion of the material[s] of the masses, wetting of the walls by the material[s], curing of the material of the masses or a combination thereof. As an example, for automotive applications, the materials of the masses and/or sealant can be configured to undergo activation to activate (e.g., expand, foam, cure, adhere, thermoset or a combination thereof) at temperatures experienced in an e-coat or paint bake oven typical to automotive processing. Such temperatures are typically at least about 100° C., more typically at least about 150° C. and more typically at least about 180° C. and is typically less than about 400° C., more typically less than about 300° C., although higher and lower temperatures are possible

The sealer (i.e., the agglomeration) can be formed and shaped (e.g., molded, pressed together, heated or combination thereof) to at least partially correspond to the cavity into which the sealer is inserted, however other shapes can be desirable. The sealer can be held in a desired position within the cavity by virtue of the shape of the sealer forming an interference fit within the cavity, through the used of fasteners, a combination thereof or the like. As an example, a push pin could be extended into the sealer and into an opening of the structure into which the sealer is placed thereby holding the sealer in place. As another example, the sealant material could be compressed upon insertion of the sealer in the cavity thereby interference fitting the sealer in the cavity. As such, it is preferable that the sealer (e.g., baffle) is without any carrier and that the sealer material and particularly both types of masses of the sealer is at least 70%, 85%, 95% or greater by volume or weight of the entire sealer.

Typically upon insertion and after activation, the sealer fills a first substantial volume of the cavity and can, if desired, be configured to substantially entirely fill a section of a cavity in which the member has been placed. In such an embodiment, the sealer can typically continuously span across a cross-section of the cavity for inhibiting or prohibiting the passage of mass (e.g., dust and debris) and or sound (e.g., noise) through the cavity and/or acting as a baffle.

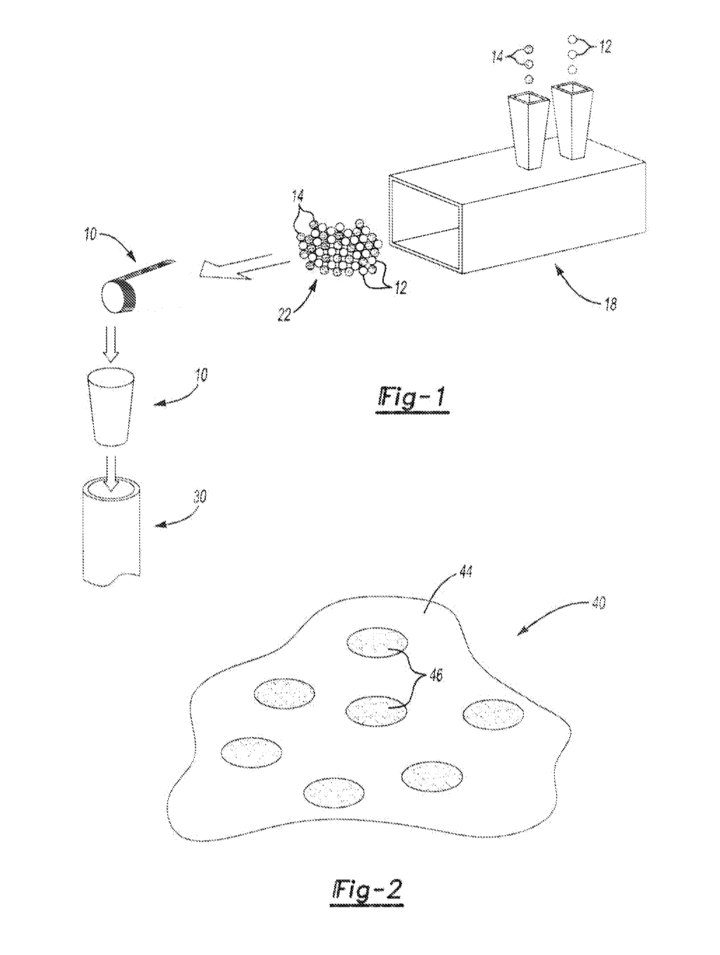

Various machines may be employed for forming the agglomeration, the sealer or both. Such machines include an extruder (co-extruder, compression molding machine, heated press, extrude-in-place system, injection molding machine, the like or other machines specifically designed to apply heat, pressure or both to the masses. With reference to FIG. 1, a process of forming a sealer 10 is illustrated. As can be seen, first and second masses 12, 14 are fed to a machine 18 that heats and compresses the masses to fuse the masses together and form an agglomeration 22. The agglomeration 22 can be used directly as a sealer or the agglomeration may be cut (e.g., die cut) to form the sealer 10 to a desired shape. Then, the sealer 10 can be inserted within a cavity of a structure 30 of an article of manufacture such as a pillar of an automotive vehicle and activated for sealing and/or baffling that cavity or structure.

It is also contemplated that the sealer of the present invention could include a single first mass with a plurality of second masses or a single second mass with a plurality of first masses that are combined to form the agglomeration. In such an embodiment, the single mass would be a continuous phase with the plurality of masses dispersed within that phase. With reference to FIG. 2, a close-up sectional view of a portion of an agglomeration or sealer 40 is illustrated. The sealer 40 includes a first mass 44 of lower or non-expanding material and a plurality of second masses 46 of higher expanding material dispersed within the first mass 44. Advantageously, the sealer 40 can be process and used as described herein.

As yet another addition or alternative, it is contemplated that the sealer of the present invention can include a single first mass combined with a single second mass forming the agglomeration. In such an embodiment, the single first mass and single second mass can be provided as layers laminated together for forming the agglomeration. Alternatively, the single first mass and single second mass may be provided in a variety of other configurations such as side by side, one on top of the other or otherwise. Such embodiments, like all of the other embodiments included herein, can include a fastener for attachment of the sealer within a cavity. Moreover, such embodiments, like all the other embodiments included herein, can be formed according to techniques described herein such as extrusion (e.g., co-extrusion).

The sealer of the present invention is typically or primarily employed for sound (e.g., noise) reduction within an article of manufacture (e.g., used as a baffle within a cavity of an automotive vehicle). It is contemplated, however, that the sealer may be additionally or alternatively used as a separator, a reinforcement, a hole plug, a blocking member, an opening sealer a combination thereof or the like.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A method of forming a sealer, the method comprising:
providing at least one or a plurality of first masses of activatable material wherein the activatable material of the first masses is either a relatively low expanding material or non-expanding material;
providing a plurality of second masses of activatable material wherein the activatable material of the second masses is a relatively high expanding material as compared to the activatable material of the first masses and wherein the plurality of first masses includes as least five masses;
agglomerating the plurality of first masses with the plurality of second masses for forming a sealer wherein the plurality of second masses or both are configured to expand and adhere to walls of the structure when exposed to an elevated temperature during automotive processing.

2. A method as in claim 1 wherein the at least one or a plurality of first masses includes at least 5 masses and the activatable material of the first masses includes at least about 10% by weight epoxy resin.

3. A method as in claim 1 wherein the activatable material of the at least one or a plurality of first masses expands to a volume that is at least 140% but less than 500% relative to its original volume before expansion.

4. A method as in claim 1 wherein the activatable material of the second masses includes an acrylate, an acetate or both.

5. A method as in claim 1 wherein the activatable material of the second masses expands to a volume that is at least 700% relative to its original volume before expansion.

6. A method as in claim 1 wherein the activatable material of the second masses includes a filler with an aspect ratio of greater that 4 to 1.

7. A method as in claim 1 wherein the elevated temperature experienced during automotive processing is at least 150° C.

8. A method as in claim 1 wherein the sealer is shaped to correspond to the cavity of the structure of the automotive vehicle.

9. A method as in claim 1 wherein the sealer is held in a desired position within the cavity by virtue of the shape of the sealer forming an interference fit within the cavity.

10. A method as in claim 1 wherein a push pin extends into the sealer and into an opening of the structure into which the sealer is placed thereby holding the sealer in place.

11. A method as in claim 1 wherein the at least one or a plurality of first masses and the plurality of second masses are at least 85% by weight of the sealer.

12. A method as in claim 1 wherein the sealer, after activation, continuously spans across a cross-section of the cavity for inhibiting the passage of mass, sound or both through the cavity thereby acting as a baffle.

13. A method of baffling or sealing a structure, the method comprising:
providing a plurality of first masses of activatable material wherein:
i. the activatable material of the first masses is either a relatively low expanding material or non-expanding material;
ii. the plurality of first masses includes as least five masses;
iii. the activatable material of the first masses includes at least about 10% by weight epoxy resin; and
iv. the activatable material of the first masses expands to a volume that is at least 140% but less than 500% relative to its original volume before expansion;
providing a plurality of second masses of activatable material wherein:
i. the activatable material of the second masses is a relatively high expanding material as compared to the activatable material of the first masses;
ii. the plurality of first masses includes as least five masses;
iii. the activatable material of the second masses includes an acrylate, an acetate or both;
iv. the activatable material of the second masses expands to a volume that is at least 700% relative to its original volume before expansion agglomerating the plurality of first masses with the plurality of second masses for forming a sealer; and
locating the sealer within a cavity of a structure of an automotive vehicle wherein the plurality of first masses, the plurality of second masses or both are configured to expand and adhere to walls of the structure when exposed to an elevated temperature during automotive processing and wherein the elevated temperature experienced during automotive processing is at least 150° C. and wherein the sealer is shaped to correspond to the cavity of the structure of the automotive vehicle and wherein the sealer, after activation, continuously spans across a cross-section of the cavity for inhibiting the passage of mass, sound or both through the cavity thereby acting as a baffle.

14. A method as in claim 13 wherein the activatable material of the second masses includes a filler with an aspect ratio of greater that 4 to 1.

15. A method as in claim 13 wherein the sealer is held in a desired position within the cavity by virtue of the shape of the sealer forming an interference fit within the cavity.

16. A method as in claim 13 wherein a push pin extends into the sealer and into an opening of the structure into which the sealer is placed thereby holding the sealer in place.

17. A method as in claim 13 wherein the first masses and second masses are at least 85% by weight of the sealer.

18. A sealer for baffling a structure of an automotive vehicle, the sealer comprising:
a plurality of first masses of activatable material wherein:
i. the activatable material of the first masses is either a relatively low expanding material or non-expanding material;
ii. the plurality of first masses includes as least five masses;
iii. the activatable material of the first masses includes at least about 10% by weight epoxy resin; and
iv. the activatable material of the first masses expands to a volume that is at least 140% but less than 500% relative to its original volume before expansion;
a plurality of second masses of activatable material wherein:
v. the activatable material of the second masses is a relatively high expanding material as compared to the activatable material of the first masses;
vi. the plurality of first masses includes as least five masses;
vii. the activatable material of the second masses includes an acrylate, an acetate or both;
viii. the activatable material of the second masses expands to a volume that is at least 700% relative to its original volume before expansion
wherein the plurality of first mass and the plurality of second masses are agglomerated together to form the a sealer and wherein the plurality of first masses, the plurality of second masses or both are configured to expand and adhere to walls of the structure when exposed to an elevated temperature during automotive processing and wherein the elevated temperature experienced during automotive processing is at least 150° C. and wherein the sealer is shaped to correspond to the cavity of the structure of the automotive vehicle and wherein the sealer, after activation, continuously spans across a cross-section of the cavity for inhibiting the passage of mass, sound or both through the cavity thereby acting as a baffle and the first masses and second masses are at least 85% by weight of the sealer.

19. A sealer as in claim 18 wherein the activatable material of the second masses includes a filler with an aspect ratio of greater that 4 to 1.

20. A sealer as in claim 18 wherein:
i. the sealer is configure to be held in a desired position within the cavity by virtue of the shape of the sealer forming an interference fit within the cavity; or
ii. a push pin extends into the sealer and into an opening of the structure into which the sealer is placed thereby holding the sealer in place.
